(19) United States
(12) Patent Application Publication
(10) Pub. No.: US 2002/0174335 A1
(43) Pub. Date: Nov. 21, 2002

(54) IP-based AAA scheme for wireless LAN virtual operators

(76) Inventors: Junbiao Zhang, Highland Park, NJ (US); Jun Li, Highland Park, NJ (US); Stephen Weinstein, Summit, NJ (US); Nan Tu, Princeton, NJ (US)

Correspondence Address: SUGHURE MION, PLLC, 2100 Pennsylvania Avenue, NW, Washington, DC, 20037-3213, US

(21) Appl. No.: 09/989,157

(22) Filed: Nov. 21, 2001

Related U.S. Application Data
(60) Provisional application No. 60/279,724, filed on Mar. 30, 2001.

(51) Int. Cl. G06F 15/16; H04L 9/00

(52) U.S. Cl. 713/168; 709/229; 380/270

(57) ABSTRACT

Mobile users access the Internet and local network services at hot spots such as airports, hotels, coffee shops and vacation resorts. The mobile users' Internet Service Providers (ISPs) are used as the single point of contact for all authentication, accounting, and authorization (AAA) transactions. AAA transactions for such ISPs acting as “virtual operators” are handled according to a system entirely based on IP. Converging both the AAA process and data transmission at the IP layer works across multiple air interfaces and is interoperable with wireless LAN cards from different vendors.

### CROSS-REFERENCE TO RELATED APPLICATIONS

This application claims the benefit of U.S. Provisional Application No. 60/279,724, filed Mar. 30, 2001. Application No. 60/279,724 is incorporated herein by reference in its entirety.

### BACKGROUND OF THE INVENTION

### Background Reading

The documents identified below provide useful background information on wireless technology. In the ensuing description, abbreviated reference to these documents is conveniently made using the corresponding letter shown by each document.

(A). IEEE standard, “Information technology—Telecommunication and information exchange between systems—Local and metropolitan area networks—Specific requirements—part 11: Wireless LAN Medium Access Control (MAC) and Physical Layer (PHY) specifications”.

(B). Bluetooth Special Interest Group, “The Bluetooth Specification”, http://www.bluetooth.com/developer/specification/core_{—}10_b. pdf.

(C). Apple Computer, Inc., “Airport Wireless Networking: A Technical Overview”, http://www.apple.com/airport/pdf/Airport_WP-b.pdf.

(D). Lucent Technologies, “ORiNOCO Overview”, ftp://ftp.orinocowireless.com/pub/docs/ORINOCO/BROCHURES/or inoco.pdf.

(E). Cisco Systems, “Cisco Aironet 350 Series Wireless LAN Security”, http://www.cisco.com/warp/public/cc/pd/witc/ao350ap/prodlit/a350w_ov.htm.

(F). Nokia Corporation, “The Nokia Public Access Zone Solution”, http://www.nokia.com/serviceproviders/pdfs/paz_brochure.pdf

(G). Nokia Corporation, “The Nokia Operator Wireless LAN”, http://nokia.com/press/background/pdf/OWLAN.pdf.

(H). Stephen Weinstein, Jun Li, Junbiao Zhang, Nan Tu, “Public Access Mobility LAN: Extending the Wireless Internet into the LAN Environment”, Accepted by IEEE Personal Communications Magazine, Special Issue on Mobile and Wireless Internet: Architectures and Protocols (not yet published).

(I). HiperLAN2 Global Forum, “HiperLAN/2—The Broadband Radio Transmission Technology Operating in the 5 GHz Frequency Band”, http://www.hiperlan2.com/web/pdf/whitepaper.pdf.

(J). HomeRF Working Group, “HomeRF Technical Overview Presentation”, http://www.homerf.org/data/tech/techpres.pdf.

(K). IP Security Protocol Charter, “IP Security Protocol”, http://www.ietf.org/html.charters/ipsec-charter.html.

(L). Charles E. Perkins, “Mobile IP Joins Forces with AAA,” IEEE personal Communications, August, 2000.

The foregoing documents are incorporated by reference in their entirety for their useful background information, as indicated in the remainder of this description.

### Related Work

Wireless LAN (WLAN) technologies, especially the IEEE 802.11 b standard, have received great attention in recent years. Commercial products such as Apple's Airport (C), Lucent's WaveLAN (D), and Cisco's Aironet (E) are widely available on the market and are making wireless LAN accesses fast, convenient and economical. Wireless LAN Access points (AP) are not only installed in corporate environments as a convenient extension to the wired LAN, but are starting to be deployed in public hot spots such as airports, hotels and Internet cafes as a means for public Internet access. Mobile users can get fast and reliable Internet access at these hot spots using their laptop computers or other mobile devices. A mobile terminal (MT) connects to an Ap through a WLAN and uses the wired LAN to which the AP attached as a gateway for Internet access.

Two business models are possible for a commercial WLAN at a hot spot: free access to attract customers (e.g. Internet Café), or paid access. In this description, the latter model is assumed.

In order to ensure the proper operation under this model, it is critical that Authentication, Authorization and Accounting (AAA) be carefully done. Due to the transient nature of the WLAN usage scenario, it would be quite inconvenient and undesirable if a mobile user had to maintain an account with each WLAN provider or had to go through the payment transaction process (e.g. credit card) each time he starts using a WLAN. Such an inconvenience would reduce the user's interest in using the WLAN services and would mean less business opportunities for the WLAN operators.

One promising solution to this problem is to use the mobile user's Internet Service provider (ISP) for all AAA transactions. The WLAN access experience for the mobile user would then be just like any typical Internet access experience. In effect, these ISPs serve as virtual operators that maintain contractual relationships with WLAN providers. Such a solution is mutually beneficial: It allows the ISPs to provide additional revenue generating services and increase their user base. The convenience and the security assurance from the same ISP also give mobile users greater interest and confidence in using the WLAN services.

In this discussion, the terms “virtual operator” and “ISP” may therefore be used interchangeably. It will be appreciated that a virtual operator ISP need not at all be the same ISP as the ISP that provides Internet connectivity to the WLAN provider.

It can be envisioned that a single WLAN operator may maintain contracts with several ISPs. To each ISP, the WLAN appears as a dedicated LAN for the ISP's mobile subscribers to access the Internet. Such a conceptually dedicated LAN is important for many reasons such as per ISP Service Level Agreement (SLA) provisioning, security enforcement and service billing.

In essence, the goal of any virtual operator AAA scheme is to build the trust relationship among mobile users, access points and ISPs. There are many challenges to the design of a sound and efficient AAA scheme. Among them, the following are most prominent:

### Mutual Authentication

Access points need to authenticate wireless users to ensure that only authorized users can access the Internet and local services/resources

Wireless users need to make sure that the access point is not a “rogue access point” which intercepts user traffic and steals information

### Key Distribution

Because mobile users can use wireless services at any public hot spots, it cannot be assumed that the users know the shared key (broadcast key or per session key) with each access point.

### Open Air Problem

Before a shared key is agreed upon by both the mobile user and the access point, the transmission between the user and the access point may be captured by anyone. No sensitive information (e.g. clear text password) can be exchanged at this stage.

### Accounting Dispute

Because virtual operators and WLAN operators are in separate administrative domains, the virtual operators cannot fully trust the WLAN operators to provide accurate accounting information. They must have a means to resolve accounting disputes with / of mobile users.

### SUMMARY OF THE INVENTION

In this description, there is a discussion of various existing virtual operator AAA solutions, and also a presentation of a novel solution that is entirely based on IP. By converging both the AAA process and data transmission at the IP layer, the solution described herein is very simple to implement and flexible.

IPSEC is used between access points and mobile terminals for per-packet authentication. In an embodiment, IPSEC is used for per-packet encryption. This provides a widely available strong security solution that gets around the problems in the Wired Equivalence Privacy (WEP) algorithm and the lack of multiple session key support in most AP products. A packet filtering function employed at an AP, similar to the firewall function, serves as a transparent mechanism for controlling not only authentication and authorization, but also packet level accounting. With a mutual proof mechanism, embodiments of the invention avoid potential accounting disputes without requiring all mobile traffic to go through a central entity. This mutual proof mechanism thus results in a more efficient and more scalable solution.

Compared with existing solutions, embodiments of the invention are air interface independent and interoperable with wireless LAN cards from different vendors. It is thus especially useful for a public access LAN environment where multiple wireless access technologies, a diverse set of wireless products and different types of wireless operators may coexist to provide mobile users with convenient and comprehensive wireless access solutions.

The operation details are explained and compared with other solutions in the context of exemplary embodiments using IEEE 802.11 b WLANs, but it will be appreciated that all of the discussion applies to all other types of WLANs.

### BRIEF DESCRIPTION OF THE DRAWING FIGURES

FIG. 1 shows, in highly simplified schematic form, the interaction between the various entities participating in the described system according to one embodiment.

FIG. 2 shows a preferred message exchange sequence for user authentication.

FIG. 3 shows, in the format of a state machine, the operations at a mobile terminal (MT) according to an embodiment.

FIG. 4 shows, in the format of a state machine, the operations at an authentication server according to an embodiment.

FIG. 5 shows, in the format of a state machine, the operations at an access point (AP) according to an embodiment.

### DETAILED DISCUSSION OF THE PREFERRED EMBODIMENTS

The description below is organized as follows: In the section entitled “Problems with Prior Approaches,” conventional virtual operator AAA solutions are described, and there is a discussion of their strengths and weaknesses. In the section entitled, “IP based AAA scheme,” the overall framework and the general procedure of the novel AAA scheme is described. Some major differences between the inventive scheme and existing solutions are also highlighted. Then, the state machines related to the AAA process on the MT, the AP and the ISP server are presented in section entitled, “State machines”.

In this discussion, it will be appreciated that an AP may be implemented in a number of concrete ways as will be evident to one familiar with this field. In particular, an AP may include a processor and a memory under control of the processor. The memory may be provided with instructions (software) that are executed by the processor, and enable the processor to cause the AP to perform in certain ways. Likewise, an AP could be implemented entirely in hardware, or partly in hardware and software. The embodiments described herein can thus be realized in a variety of ways, and it will be understood that the invention applies to any manner in which an AP and/or wireless network can be so realized.

Problems with Prior Approaches

Several companies are now offering Wireless LAN products with virtual operator AAA support, most notably among them are Cisco, Lucent and Nokia. These products are is now discussed, along with mobile IP. As will be seen, most of these prior approaches and solutions do not address the accounting aspect of AAA, or they assume that access points are fully trusted by mobile users.

### Lucent Technologies

Lucent Technologies offers the ORiNOCO family of wireless LAN products. The ORiNOCO access points have built in mechanisms for virtual operator based authentication using the RADIUS protocol. The basic procedure is as follows.

Immediately after association, the mobile terminal and the access point start a shared key generation process using the Diffie-Hellman algorithm: First, each side generates a private key / public key pair. Then, they exchange their public keys. Finally, a shared secret key can be generated by each side from its private key and the other's public key. This is a per session key and can be used to encrypt all communication between the access point and the mobile terminal user. The problem with this communication channel is that the mobile user cannot fully trust the AP because this AP could be a rogue AP. It only prevents others from listening to their communication. After this channel is established, the mobile user then initiates a login session with the RADIUS server through the AP. Only a one way authentication (user is authenticated by the RADIUS server) is done.

The major problem with this approach is that mutual authentication is not considered. Thus a rogue AP can take advantage of the weakness in this solution and pretend to the user that the RADIUS server has approved the user. Another problem is that the secure channel establishment procedure (but not the Diffie-Hellman algorithm) is Lucent proprietary. It also requires that the APs support dynamic layer 2 session keys.

### Cisco

Cisco's wireless LAN products are based on the technologies acquired from Aironet. The virtual operator support is based on a draft standard proposal jointly submitted to the IEEE 802.11 standard group by Cisco, Microsoft, Intel, Symbol and Informed Technology. The proposed authentication procedure is described in the following.

The proposal uses 802.1x and EAP to provide a virtual link between the access point and the mobile terminal. A mobile terminal associates with an AP using open authentication (no encryption). After the association, the AP runs a filter which only lets 802.1x traffic (user authentication information) through. The user uses the AP as a relay point and mutually authenticates with the AAA server (Kerberos standard, RADIUS optional). Upon authentication, the AAA server sends both the access point and the user a per session key (encrypted). This key is used between the mobile user and the access point for a secure channel. The access point then sends the user the WEP broadcast key through this channel. Note that this channel can be trusted by the mobile user because the AP is authenticated by the user.

This solution requires modifications (albeit small changes) to both 802.1x and 802.11. It also requires mobile terminal support for 802.1x and EAP. APs need to provide support for dynamic per session keys. The most serious problem with this solution is that all session keys between MTs and APs are assigned by the ISP even though these keys should be local to each AP. This is clearly undesirable, especially when multiple ISPs are involved.

### Nokia

Nokia also has a series of wireless LAN products based on IEEE 802.11 b. From the beginning, Nokia has targeted their products for network access in public “hot spots”. Their “public access zone” solution (F), for example, provides a complete set of wireless LAN equipment to support wireless LAN for airports, hotels and railroad stations. Each set contains a number of access points and a gateway router connecting these access points to the Internet. However, judging from the available technical information about the “public access zone” solution, virtual operator support is not carefully considered. Only one way authentication is performed by the access point to ensure that mobile users have the permission to access the wireless LAN. Recently, Nokia announced their “operator wireless LAN” (G) solution. It consists of wireless LAN cards for the terminals, wireless access points, a public access controller and a GSM authentication and billing gateway. Each wireless LAN card has an integrated SIM card reader. It can thus be used for user authentication with GSM networks. The public access controller serves as a control point between the wireless LAN and the Internet. It is also responsible in relaying the authentication messages between the mobile terminals and the GSM gateway. RADIUS protocol is used between the public access controller an the GSM authentication and billing gateway. Each wireless operator LAN belongs to a single mobile operator, but global roaming can be achieved in a similar fashion as in the GSM network. This product solution is not yet available. Currently, Nokia only offers a conceptual description of this technology.

Many technical details, especially those related to the AAA aspect, are quite unclear. For example, it does not specify: (1) whether mutual authentication between the mobile terminal and the public access controller is performed; and (2) how the mobile terminal communicates with the public access controller before successful authentication and how the controller prevents users with fake identity from accessing the network.

While it is a convenient solution for the mobile users to utilize the same network for authentication and billing as used for their cellular phones, it is noted by the inventors that using Internet ISPs as virtual operators is a more generic solution. First, it is difficult to ask each mobile user to be equipped with a wireless LAN card capable of reading a SIM card, given the diversity of WLAN cards on the market.

Second, WLAN operators are currently closer to ISPs than to cellular providers in terms of offered services, i.e. IP data services. For example, it is easier for an ISP than for a cellular operator to reach an SLA (Service Level Agreement) with a WLAN operator for their mobile users. ISPs may also ask the WLAN operators to provide local services such as caching and streaming. For these reasons, the non-limiting focus of the presently preferred AAA scheme is on ISP based virtual operator scenarios.

### Mobile IP

In (L), a framework is presented in which AAA functions are integrated into mobile IP. Trust relationships among home AAA servers, local AAA servers, home agents, foreign agents and mobile stations are examined and an authentication model is proposed based on these relationships. Although the model is designed specifically for mobile IP, it is applicable to authentication in wireless LAN public access. In fact, all of the solutions discussed in the previous sections follow either part or all of such a trust model.

It should be noted that the focus of the present discussion is significantly different from (L). Whilst (L) mainly concerns with a general trust model and AAA framework, this paper concentrates on the technical methods in implementing a particular framework. This requires that both framework correctness and implementation efficiency be evaluated in a public access wireless LAN context.

Additionally, some of the issues that are not addressed in (L) are resolved in the embodiments according to the invention. These include, among others, mutual authentication between mobile stations and access points, and a proper framework to handle / avoid accounting disputes.

IP Based AAA Scheme

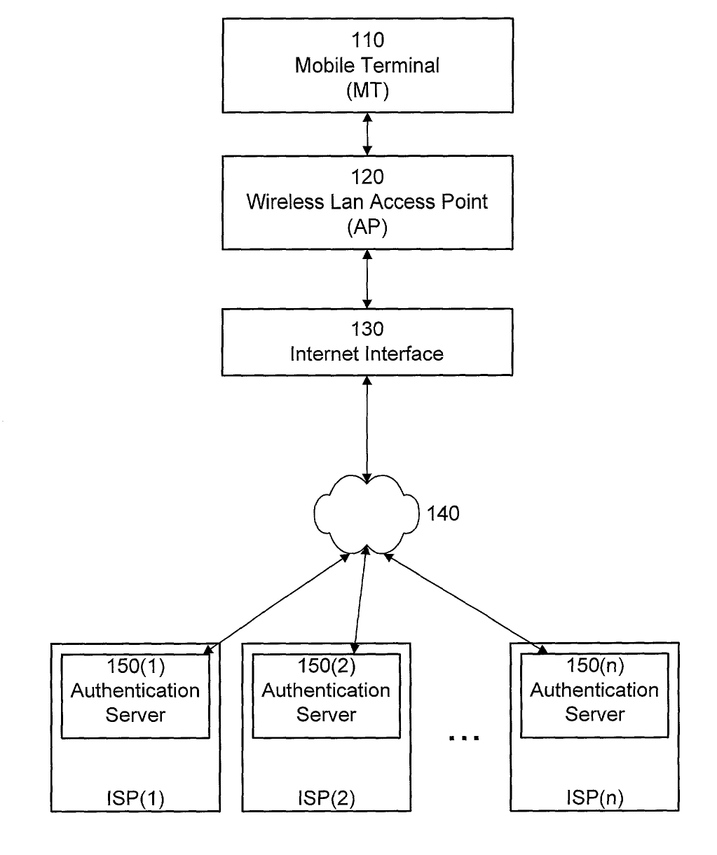

In FIG. 1, a mobile terminal (MT) 110 communicates with a wireless LAN access point (AP) 120. The AP 120 communicates with a communications network such as the Internet 140 over any interface 130 which may or may not be an integral feature of the AP 120. More particularly, an authentication client such as a RADIUS client or the like (not shown) of the AP 120 communicates with an authentication server 150, such as a RADIUS server or the like, of an Internet service provider (ISP).

FIG. 1 shows a plurality of ISP's (1, 2, . . . , n), each with a respective authentication server (150(1), 150(2), . . . 150(n)).

In the present embodiment, the entire AAA process is carried out over the IP layer. That is to say, the processing of the AAA transactions is performed using only IP layer functions. Because the processing of the AAA transactions is performed using only IP layer functions, there is no need to use any authentication, authorization, or accounting functionality of any lower layers. Because there is no need to use such functionality of any lower layers, the processing of AAA transactions is made completely independent of layers below the IP layer, and can be performed in the same manner no matter which lower layer protocols are used. Processing of the AAA transactions using only IP layer functions thus achieves wireless protocol independence for AAA transactions.

One significant feature that differentiates this approach from conventional schemes (and all other schemes from each other) is the way the AP 120 controls the authentication by the MT 110, which includes the establishment of the authentication channel, the controlling mechanism on the AP 120 and the session key assignment and management mechanisms. This requires that a router based controller be employed between the MT 110 and the ISP server for controlling MT 110 access and relaying AAA messages.

Such a controller can be either implemented in the AP 120 (e.g. as in PamLAN (H)), or in an external entity (e.g. the public access controller in Nokia's operator LAN). Since the inventive approach works essentially the same way in both cases, the router based AP 120 scenario will be assumed in the discussion hereafter of an exemplary embodiment. Because of the IP based solution, the inventive AAA scheme has at least the following benefits:

1. It works over different air interfaces (e.g. IEEE 802.11 (A), Bluetooth (B), HiperLAN2 (I), homeRF (J), 3G cellular) and across wireless LAN cards from different vendors.

2. It does not require modification to layer 2 protocols (e.g. 802.11, 802.1x)

3. It does not require that the AP 120 support layer 2 session keys since encryption can be done at the IP layer using IPSEC (K). If the AP 120 supports 802.11 per session key, our scheme can take advantage of such support easily.

### Authentication and Authorization.

In terms of the authentication scheme, the preferred embodiment is similar in some ways to the current IEEE proposal from Cisco/Microsoft. However, the present embodiment solves a few problems in the Cisco/Microsoft proposal:

1. In the Cisco/Microsoft proposal, the session keys between APs and MTs are assigned by the ISP. Since session keys are used between an AP and its associated MTs, they should be local to the AP 120. The Cisco/Microsoft proposal can be problematic when multiple ISPs are involved. Coordination among the ISPs to generate unique keys can be a difficult task. The system according to the preferred embodiment provides a mechanism which allows APs 120 to determine session keys and communicate them securely to the associated MTs.

2. The Cisco/Microsoft solution is vulnerable to denial of service attack at the step when the mobile user tries to authenticate itself with the ISP. A hacker may pretend to be the user and send a wrong authentication certificate to the AP which in turn relays it to the ISP. The ISP will immediately close the authentication session by rejecting the user. A system according to the preferred embodiment solves this problem by letting the AP 120 make more intelligent decisions when relaying user authentication certificate.

Central to the operation of the inventive system is a filtering function (not shown) installed on every AP 120. It is similar to the firewall function and filters all mobile traffic and determines whether the traffic should be let through (authenticated user traffic with the session key), sent to the authentication engine (login session traffic), or blocked (unauthorized traffic). Besides security control, the filtering function is also used for traffic classification where multi-layer packet header information may be extracted through deep packet processing.

IPSEC can be used to ensure data integrity as well as to prevent unauthorized users from pretending to be authorized ones. Each authenticated user (from a specific IP address) has a shared session key with the AP 120. If somebody fakes the source IP address in the packet without knowing the shared key, the IP packet headers will not be correctly decrypted and the packet will be discarded.

In an embodiment, IPSEC is thus used between access points and mobile terminals for per-packet authentication. In another embodiment, IPSEC is used for per-packet encryption. That is, with IPSEC, it is possible to encrypt the whole packet for strong security, but this involves more complexity and also slower speed. It is also possible to use only the IPSEC Authentication Header (AH) (similar to digital signature) to ensure that the packet is from an authenticated user. With per-packet authentication, the packet is not encrypted, and this is less complicated and much faster. Per-packet authentication is good for most applications, but some will need per-packet encryption.

In an embodiment, each mobile user has two keys, a private key and a public key. The private key is also used as a single shared secret key between the user and the ISP. The private key of the user may also be referred to as the user's password. The public key is stored at the ISP as part of the user's profile. This public key will be sent to the AP 120 after user authentication. In other words, the user and the ISP authenticate each other using symmetric-key encryption with the user's password. After a successful authentication, the session key between the AP 120 and the user is encrypted by the AP 120 using public-key encryption and the result is sent to the user.

A more detailed description of an embodiment will now be presented.

When a mobile user moves into the coverage area of an AP 120, his MT 110 first establishes a layer 2 connection with the AP 120. In the IEEE 802.11 term, this is called “association ”. Since the virtual operator authentication process is used, this association step does not require any layer 2 authentication. The following procedure describes the authentication process after the association.

Note that the AP 120 has a list of ISPs with which the AP 120 has partnership agreements. The AP 120 and each authentication server 150 share a secret and all RADIUS packets exchanged between them are authenticated using this secret together with a random authenticator. Any sensitive information, such as plain text passwords, are encrypted using this shared secret.

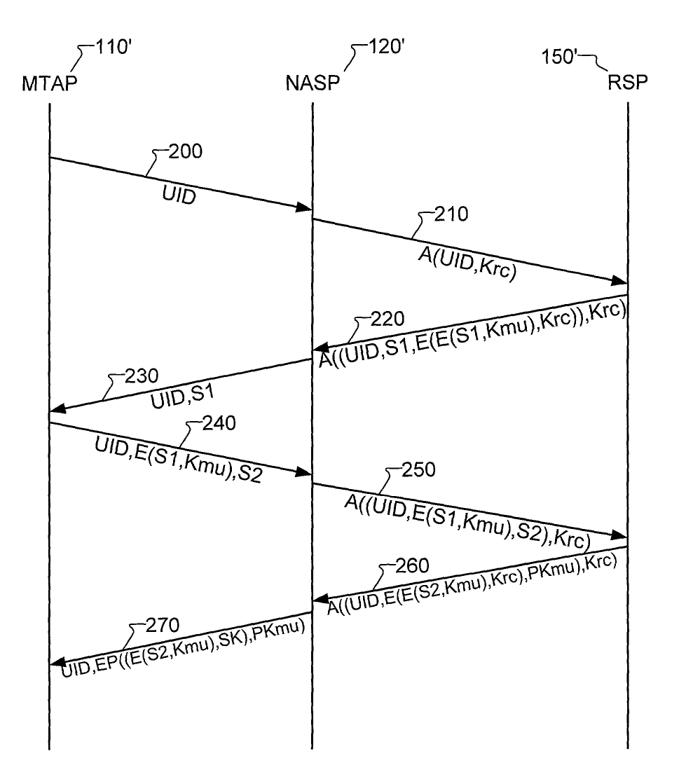

FIG. 2 illustrates the message exchanges among the mobile terminal access procedure 110′ of the MT 110, the network access server procedure 120′ of the AP 120, and the authentication server procedure 150′ of the authentication server of the ISP (a RADIUS server process, in this example, RSP 150′) for a successful authentication. The contents of the messages are summarized using abbreviations, and the following table may be used to understand the abbreviations and, hence, the content of the messages.

| | |
|---|---|
| MTAP | Mobile Terminal Access Procedure |
| NASP | Network Access Server Procedure |
| RSP | Radius Server Procedure |
| UID | User identifier |
| S | Random string generated by authentication server |
| S₂ | Random string generated by mobile terminal. |
| E (M, K) | M is encrypted with key K using symmetric-key |
| | encryption |
| EP (M, K) | M is encrypted with key K using public-key |
| | encryption |
| A (M, K) | N is encrypted for authentication with key K using |
| | MD5 |
| Kmu | Shared secret between the mobile user and RSP |
| Krc | Shared secret between RC and RSP |
| SK | Session key between mobile user and RC |
| Pkmu | Mobile user’s public key |

1. The AP 120 assigns the MT 110 a dynamic IP address with the help of a DHCP server. The AP 120 also installs a filter for the IP address. At this stage, all IP traffic from this address is filtered and terminated by the AP 120 and assumed to be authentication packets.

2. The user initiates a login session with his ISP. The ISP id and the user id are sent to the AP 120. This user initiated login message 200 is shown in FIG. 2.

3. The AP 120 sends the user's authentication server (a RADIUS server in this example; RSP 150′) an Access-Request packet 210 with the user id.

4. The RSP 150′ makes a validity determination with respect to the user id contained in the Access-Request packet 210. If the user id is valid, the RSP 150′ generates a random string S₁ and encrypts it using the user's password into string SS¹. It then sends back the AP 120 an Access-Challenge packet 220 with S₁ and SS¹. SS¹ is encrypted using its shared secret with the AP 120.

5. The AP 120 is responsive to receiving, from the RSP 150′, the Access-Challenge packet 220, and in response thereto it forwards S1 to the MT 110 in a forwarded Access-Challenge packet 230, and it saves SS¹ locally.

6. The MT 110 encrypts S₁ using its password with the ISP. This encrypted string, SS₁, together with another randomly generated string, S₂, are sent to the AP 120 in an Access-Challenge MT Response packet 240.

7. If SS¹ and SS₁ do not match, the Access-Challenge MT Response packet 240 received from the MT 110 in step 6 is simply ignored by the AP 120, and then the AP 120 waits until it receives another encrypted S₁ in another Access-Challenge MT Response packet or times out. As explained in more detail below, this extra checking is done to prevent the denial of service attack mentioned earlier. If SS¹ and SS₁ match, the AP 120 sends a Follow-up Access-Request packet 250 to the RSP 150′ with the user id, SS₁ and S₂.

8. The RSP 150′ uses the user's password to decrypt SS₁ and compares the result with S₁, if they match, it encrypts S₂ with the user's password (denotes the result as SS₂) and sends the AP 120 an Access-Accept packet 260 with both SS₂ and the user's public key PK encrypted using its shared secret with the AP 120. If the decrypted result does not match with S₁, it sends back an “Access-Reject” packet (instead of the access-Accept packet 260).

9. If the AP 120 receives an “Access-Reject”, it denies the user access. Otherwise, in response to receiving the Access-Accept packet 260 it notifies the user of successful login and forwards the user SS₂, the user's session key and the WEP broadcast key, all encrypted with PK using public key encryption in a Login-Accept packet 270. When the user receives this encryption result, he first decrypts it with his password using private key decryption and obtains SS₂, the session key and the WEP key. He then decrypts SS₂ with his password using symmetric decryption and compares the result with S₂. If they match, he knows that the ISP and the AP 120 can be trusted. Furthermore, the user may start using the AP 120, which has already changed the filter to let through all traffic from the user's IP address.

Note that at step 4, the RSP 150′ sends AP 120 both S₁ and SS¹ in the Access-Challenge packet 220. That is to say, the access challenge packet from the authorization server includes not only the random string (i.e., S₁), but also a version of the random string encrypted with the user's own password (SS¹).

This solves the denial of service attack vulnerability in the Cisco approach where only S₁ is sent to the AP 120. To see how the attack is possible, consider the following scenario: at step 5, a hacker at a different MT may notice that the AP 120 asks the MT 110 to reply to the ISP's challenge. The hacker can pretend to be the MT 110 and send the AP 120 some garbage string.

The AP 120 then dutifully forwards this string to the RADIUS server thinking it is the reply, of the actual user at MT 110, to the challenge. However, since it is the wrong response sent by the hacker, a conventional authorization server will immediately reject the request of the user at MT 110 and close the authentication session. Thus, the hacker can deny service to the actual user at MT 110.

In a system operating according to the preferred embodiment, since the AP 120 knows the encryption result for S₁, if someone fakes a reply, the reply will be immediately discarded at the AP 120 without affecting the actual authentication session. Of course, if the original authenticating user is a fake, the AP 120 allows the authentication session to live longer than necessary and terminates the authentication session with timeout. Compared to the more serious problem of being denied of services, this is a small price to pay. The timeout value can be properly set to limit the problem.

### Accounting

In the virtual operator model described herein, the virtual operators and the WLAN operators might not be in the same administrative domains. This may cause potential problems, especially in terms of accounting, between these entities. For example, a WLAN operator may overcharge a mobile user by mistake, or a dishonest mobile user may deny some reported usage.

One approach that has been used by some solutions to avoid such potential disputes is to route all mobile user traffic through a central entity. Under such an approach, e.g., all packets from mobile users belonging to virtual operator AOL would be routed first to a central AOL server for accounting purposes. This having been accomplished, the central server then routes the packets on to their intended destinations over the Internet. Such an approach may be referred to as a centralized accounting approach. The centralized accounting approach is highly inefficient, however, since it creates an unnecessarily complicated routing path and considerably slows down mobile user access.

According to an embodiment of the invention, an effective accounting solution is employed without requiring all mobile traffic to be routed through a central virtual operator server (i.e., without centralized accounting).

In this embodiment, decentralized accounting is achieved by using mutual accounting proof from both the mobile users and the wireless LAN operators. In other words, the AAA transactions achieve decentralized accounting by accounting proofs mutual to the MT and the AP.

In particular, to avoid possible disputes, the virtual operator is furnished with proof that the MT user and the AP of the WLAN operator both report substantially the same traffic usage history. One exemplary method for producing mutual accounting proofs is as follows:

1. On the MT, a traffic monitoring module monitors wireless LAN traffic after the user login and periodically compiles a traffic usage profile or record.

2. The MT signs this profile / record with a digital signature, using the mobile user's shared secret with the virtual operator.

3. The signed MT profile is sent to the AP.

4. The AP checks the information in the profile against the statistics for that MT as collected by the AP's filter.

5. When the AP statistics match the MT statistics (within a tolerable error margin), the profile is deemed to be a verified profile.

6. Verified profiles are forwarded to the virtual S operator. Since all communication between the AP and the virtual operator is authenticated, the verified profile provides the ISP with proof that both the MT and the AP agreed on the profile.

7. When the AP statistics are so different from those of the MT that there is no match, the AP may simply block the MT (i.e., terminate the service) or offer the MT the option to be blocked or to readjust the MT stats.

### Potential Problems

Fake IP attack. Because the initial DHCP process happens in a non-secure channel, a hacker may easily learn the authorized user's IP address and MAC address. He can then fake his communications to reflect the same IP address. Since the filter for that IP address has been changed to allow all traffic through, the hacker can gain unauthorized wireless access. This actually is a common problem with all access solutions that do not use per session keys. Since individual session keys are used in the inventive system, this problem can be easily avoided through packet encryption either at layer 3 (IPSEC) or layer 2 (802.11 encryption). IPSEC is more generic and does not require per session key support from 802.11 (AP 120 has to dynamically determine which key to use for different packets).

However, it most likely will be done in software and cannot take advantage of the hardware encryption built in the 802.11 MAC layer (albeit optional). Thus, the 802.11 per session key should be used if supported. To use layer 2 encryption, the filter at the AP 120 needs to check the mapping between the mobile's IP address and MAC address. If a hacker fakes the same IP address and the same MAC address, encryption by the 802.11 protocol would render his effort useless. The only possibility is then to fake the same IP address but a different MAC address, but this can be caught by the filter.

Denial of DHCP service. Because DHCP request occurs before authentication, a hacker may constantly initiate the login session with fake MAC addresses. He may then occupy some IP addresses and may slow down others in gaining DHCP service. This can be partly mitigated by properly setting the time out value for user's login session. Because the attacker cannot successfully authenticate himself, he will be kicked out quickly. Note that this problem is no more serious than the “air jamming” attack which cannot be effectively prevented.

### Fast Handoff

When the user moves to a different AP 120, it is possible to perform a fast handoff such that the user does not have to go through the authentication process all over again. In most cases, such a fast handoff can be achieved based on the trust relationship between the new and the old AP 120s. Given that both APs 120 reside in the same public access LAN, such a trust relationship should not be a problem. In case two APs cannot trust each other, they can use the ISP as the relay point for the following fast handoff procedure.

After the reassociation, the new AP 120 contacts the old AP 120, notifies the old AP 120 about the reassociation and fetches the user profile (including the user's public key and the session key) from the old AP 120. The new AP 120 then encrypts the new session key it shares with the user together with the old session key using the user's public key. The user then decrypts these keys and compares the old session key with the one he/she has. If the two matches, the user establishes a new session with the new AP 120.

The reason the new AP 120 does not use the old session key to encrypt the new session is because the session keys are local to each AP 120. Thus there is certain possibility (albeit remote) that the old session key may be already used in the new AP 120.

State Machines

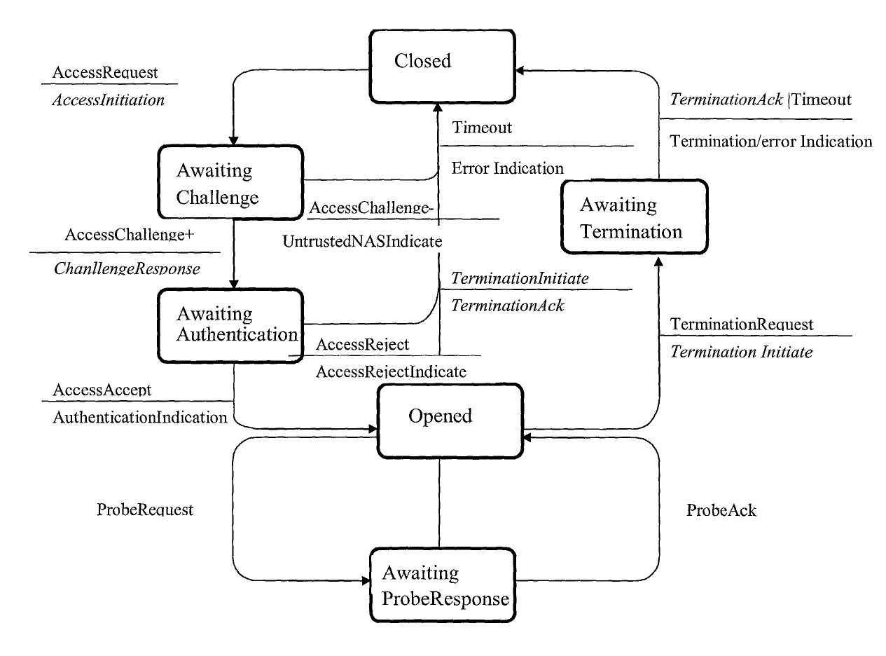

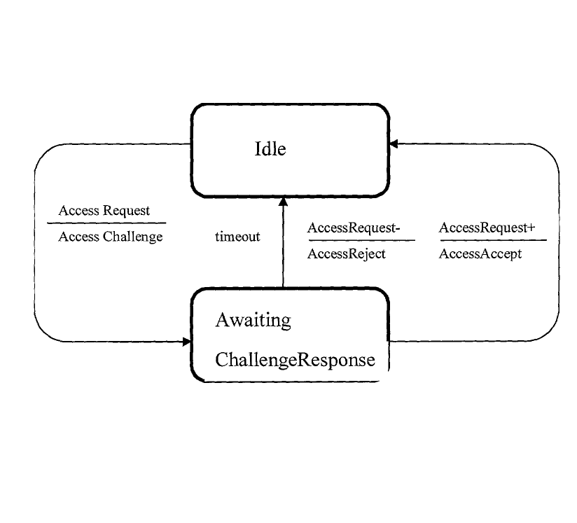

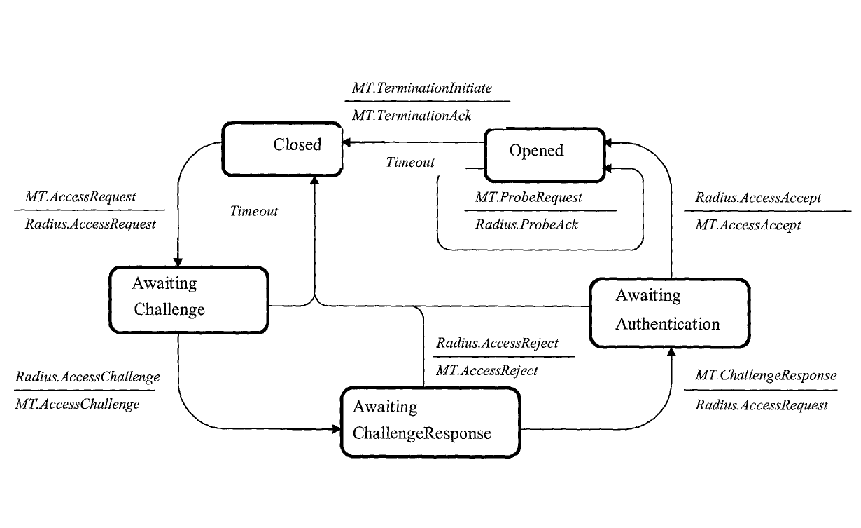

In this section, exemplary state machines are presented for: the mobile terminal access procedure MTAP 110′ on the mobile terminal MT 110 (FIG. 3), the network access service procedure NASP 120′ on the access point AP 120 (FIG. 5) and the authentication server procedure (in this exemplary embodiment, a RADIUS Server procedure (RSP)) of the ISP (FIG. 4). Detailed explanations on the operations of these state machines will also be given.

It will be appreciated that this detailed explanation is simply provided for the sake of a thorough discussion, and is not at all meant to be construed as a limiting example.

### Mobile Terminal Access Procedure (MTAP)

Operations:

1. Connection Establishment

At this stage, the MTAP 110′ tries to create an authenticated connection with the NASP 120′ on the AP 120.

Beginning with state Closed, the mobile user initiates a network access session by issuing an AccessRequest primitive to the MTAP 110′. The MTAP 110′ responds by sending an AccessInitiation message to the NASP 120′ and starting a timer timer1. It then transits to the AwaitingChallenge state. If it receives an AccessChallenge+ message at this state, it means that the RSP 120′ recognizes the AP 120 and the mobile user. The MTAP 110′ sends a ChanllengeResponse message with encrypted challenge string to AP 120 and reset timer1, then transits to AwaitingAuthentication state. If MTAP 110′ receives indication (AccessChallenge- message) that the RSP 120′ does not accept the AP 120 or the mobile user, it goes to Closed state directly. At state AwaitingAuthentication, once receiving an AccessAccept message, the MTAP 110′ indicates to the user with Authentication primitive. The MTAP 110′ then goes to the Opened state. If receiving an AccessReject message, the MTAP 110′ goes to the Closed state. After transiting to the state Closed, timer1 is deleted.

If the MTAP 110′ receives a time-out event in any transit state, the MTAP 110′ goes to the Closed state and indicate to the user with the error message, and timer1 is set to 2*RTT.

2. Connection Refreshment

At this stage, the MTAP 110′ tries to keep the connection by sending the probeRequest message to the NASP 120′ periodically, as determined by timer2, and then goes to the AwaitingProbeResponse state. The NASP 120′ has an entry for each authenticated user and each entry is associated with a timer timer3. After receiving the ProbeRequest message from the MTAP 110′, the NASP 120′ resets timer 3 associated with this user and sends a ProbeAck message to the MTAP 110′. If the MTAP 110′ receives a ProbeAck message from the NASP 120′ within timer1, the MTAP 110′ returns to the Opened state and resets timer2. Otherwise, it goes to the Closed state and indicates to the user with error. If timer3 on the NASP 120′ expires, the NASP 120′ deletes the entry for this user. Timer3 should be longer than timer2. Timer1 here is the same as in connection establishment stage, which is set to 2*RTT.

3. Connection Tear-down

At this stage, the MTAP 110′ tries to close the connection to the NASP 120′.

Beginning with the state Opened, the mobile user initiates connection termination by issuing a TerminateRequest primitive to the MTAP 110′. The MTAP 110′ responds by sending a TerminateInitiate message to the NASP 120′ and starting a timer timer4. After receiving a TerminateAck from the NASP 120′, the MTAP 110′ transits to the Closed state and sends the user the TerminationSuccess message. When timer4 expired, the MTAP 110′ goes to the Closed state and sends the user the TerminationError message.

At the Opened state, after the MTAP 110′ receives the TerminateInitiate message from the NASP 120′, the MTAP 110′ responds by sending back a TerminateAck message and goes to the Closed state.

Note that ProbeAck and TerminationInitiate messages must be encrypted in order to ensure integrity. Any events or messages received in a state where it is not supposed to be received according to the state diagram will be silently discarded.

Messages and Primitives

1. Communication primitives between the MTAP 110′ and the user.

AccessRequest, AuthenticationIndicate, AccessRejectIndicate, UntrustedNASIndicate, AccessError, TeminateRequest, TerminateIndication, TerminateError

2. Communication messages between the MTAP 110′ and the NASP 120′

AccessInitiation, AccessChallenge, ChallengeResponse, AccessAccept, AccessReject, ProbeRequest, ProbeAck, TerminateInitiate, TerminateAck

### Radius Server Procedure (RSP)

Operation.

Beginning with the Idle state, if the RSP 150′ receives an AccessRequest message from the AP 120 with the CHAP attribute set and the CHAP password attribute empty, the RSP 150′ sends an AccessChallenge message to the AP 120 with the CHAP password attribute and the CHAP attribute set. It then starts a timer timer5 and goes to the AwaitingChallengeResponse state. After receiving an AccessRequest message with the same ID, if the CHAP password is correct, the RSP 150′ sends the AccessAccept message to the AP 120 and goes to the Idle state. Otherwise, it sends the AuthenticationReject message to the AP 120. Timeout of timer5 will result in going back to the Idle state.

Messages

AccessRequest, AccessRequest+ (passed check), AccessRequest− (unable to pass check), AccessChallenge, AccessAccept, AccessReject

### Network Access Server Procedure (NASP)

Operation

MT.message and Radius.message is the lexical manner used herein to differentiate messages when messages from the MTAP 110′ and the RSP 150′ have the same name.

Beginning with state Closed, after receiving the MT.AccessRequest message, the NASP 120′ sends the Radius.AccessRequest message to the RSP 150′ and starts a timer timer6. It then goes to state AwaitingChallenge. After receiving the Radius.AccessChallenge from the RSP 150′, it sends the MT.AccessChallenge message to the MTAP 110′, resets timer6 and then goes to state AwaitingChallengeResponse. After receiving the MT.ChallengeResponse message from the MTAP 110′, it sends the Radius.AccessRequest to the RSP 150′ again, reset timer6 and then goes to state AwaitingAuthentication. If it receives Radius.AccessAccept from the RSP 150′, it sends the MT.AccessAccept message to the MTAP 110′, resets timer6 and then goes to state Opened. If it receives the Radius.AccessReject message, it sends a MT.AccessReject message to the MTAP 110′ and deletes timer6, then goes back to state Closed.

At state Opened, two events cause the NASP 120′ to go back to the Closed state, i.e. the MT.TerminateInitiate message or timer6 expires. Timer6 is reset by the MT.ProbeRequest message.

Note that any event or message received in a state where it is not supposed to be received according to the state diagram will be discarded silently. Any time-out event causes the NASP 120′ to go back to state Closed.

Messages

MT.AccessRequest, MT.AccessChallenge, MT.ChallengeResponse, MT.AccessReject, MT.AccessAccept, MT.TeminateInitiation, MT.TerminateAck, Radius.AccessRequest, Radius.AccessChallenge, Radius.AccessAccept, Radius.AccessReject

Conclusion and Generalization

“Virtual Operator” is a very useful concept in providing public Internet access with wireless LAN technologies. Mobile users can use their ISPs for Authentication, Authorization and Accounting (AAA) and conveniently access the Internet through wireless LANs at hot spots such as airports and hotels.

A system operating as described above constitutes an IP-based Virtual Operator AAA method. Compared with existing solutions, the disclosed method is simpler and more flexible. It is independent of the layer 2 wireless protocols and is interoperable with wireless LAN cards from different vendors.

In a public access LAN environment, multiple wireless access technologies, a diverse set of wireless products and different types of wireless operators may coexist to provide mobile users with convenient and comprehensive wireless access solutions. The method and AP disclosed herein are thus particularly suitable for such an environment.

There is claimed:

1. A method for effecting authentication, authorization and accounting (AAA) transactions in a wireless network, comprising:
establishing an association between a mobile terminal (MT) and an access point (AP);
establishing an authentication channel between the AP and an Internet service provider (ISP); and
communicating AAA messages, to effect said AAA transactions, between the MT and the AP, and between the AP and the ISP;
wherein said processing of said AAA transactions is performed using only IP layer functions.

2. The method for effecting authentication, authorization and accounting (AAA) transactions in a wireless network as set forth in claim 1, wherein said communicating of said AAA messages comprises:
until an affirmative authentication determination, filtering all traffic from the MT at the AP so that the traffic is not passed beyond the AP;
sending an Internet service provider (ISP) identifier and a user identifier (UID) from the MT to the AP;
sending the UID from the AP to the ISP indicated by the ISP identifier;
at the ISP, randomly generating a string S₁ and encrypting S₁ with a password of the user to provide encrypted version SS¹;
sending S₁ and SS¹ from the ISP to the AP;
storing SS₁ at the AP;
sending S₁ from the AP to the MT;
at the MT, encrypting S₁ with the password of the user to provide encrypted version SS₁, and randomly generating a second string S₂;
sending SS₁ and S₂ from the MT to the AP;
making the authentication determination at the AP, wherein:
when SS¹=SS ₁, the authentication determination is affirmative,
only when the authentication determination is affirmative, sending the UID, SS₁, and S₂ from the AP to the ISP;
at the ISP, only when SS¹32 SS₁:
accepting access by the MT;
encrypting S₂ with the password of the user to provide encrypted version SS², and
sending SS² from the ISP to the AP;
sending SS² from the AP to the MT;
at the MT:
decrypting SS² to provide a decrypted version S² of the second string from the ISP; and
sending subsequent traffic to the AP only when S₂=S²;
wherein, when the authorization determination is affirmative, the subsequent traffic from the MT is passed beyond the AP without the filtering.

3. The method for effecting authentication, authorization and accounting (AAA) transactions in a wireless network as set forth in claim 2, wherein the step of sending SS² from the AP to the MT also includes sending to the MT a session key and a broadcast key, and wherein the session key is used for encryption of the subsequent messages from the MT.

4. The method for effecting authentication, authorization and accounting (AAA) transactions in a wireless network as set forth in claim 1, wherein communications between the MT and the AP are performed over an air interface complying with the IEEE 802.11 standard.

5. The method for effecting authentication, authorization and accounting (AAA) transactions in a wireless network as set forth in claim 1, wherein communications between the MT and the AP are performed over an air interface complying with the Bluetooth standard.

6. The method for effecting authentication, authorization and accounting (AAA) transactions in a wireless network as set forth in claim 1, wherein communications between the MT and the AP are performed over an air interface complying with the HiperLAN2 standard.

7. The method for effecting authentication, authorization and accounting (AAA) transactions in a wireless network as set forth in claim 1, wherein communications between the MT and the AP are performed over an air interface complying with the homeRF standard.

8. The method for effecting authentication, authorization and accounting (AAA) transactions in a wireless network as set forth in claim 1, wherein communications between the MT and the AP are performed over an air interface complying with a cellular 3G standard.

9. The method for effecting authentication, authorization and accounting (AAA) transactions in a wireless network as set forth in claim 1, wherein communications between the MT and the AP are performed without modification to any layer 2 standard protocols.

10. The method for effecting authentication, authorization and accounting (AAA) transactions in a wireless network as set forth in claim 1, wherein IPSEC is used for per-packet encryption of messages from the MT.

11. The method for effecting authentication, authorization and accounting (AAA) transactions in a wireless network as set forth in claim 1, wherein an IPSEC authentication header is used for per-packet authentication of messages from the MT.

12. A method for an access point (AP) to support authentication, authorization and accounting (AAA) transactions in a wireless network, comprising:
accepting an association with a mobile terminal (MT);
establishing an authentication channel with an Internet service provider (ISP); and
receiving AAA messages sent from the MT, and sending corresponding AAA messages to the ISP, to effect said AAA transactions;
wherein processing of said AAA transactions is performed using only IP layer functions.

13. The method for effecting authentication, authorization and accounting (AAA) transactions in a wireless network as set forth in claim 12, wherein said receiving and said sending of said AAA messages comprises:
until an affirmative authentication determination, filtering all traffic from the MT so that the traffic is not passed beyond the AP;
receiving an Internet service provider (ISP) identifier and a user identifier (UID) from the MT;
sending the UID from the AP to the ISP indicated by the ISP identifier;
receiving a first encrypted string SS¹ and a first string S₁ from the ISP;
sending S₁ to the MT;
receiving from the MT a second encrypted string SS₁;
when SS¹=SS₁:
making the affirmative authentication determination,
sending the UID and SS₁ to the ISP, and
passing subsequent traffic from the MT without the filtering.

14. The method for effecting authentication, authorization and accounting (AAA) transactions in a wireless network as set forth in claim 13, further comprising:
when receiving from the MT the second encrypted string SS₁, receiving also a second string S₂; and
when sending the UID and SS₁ to the ISP, sending also S₂.

15. The method for an AP to support authentication, authorization and accounting (AAA) transactions in a wireless network as set forth in claim 13, further comprising, when SS¹=SS₁, sending to the MT a session key, wherein the session key is used for decryption of the subsequent messages from the MT.

16. The method for an AP to support authentication, authorization and accounting (AAA) transactions in a wireless network as set forth in claim 12, wherein the AP performs wireless communications over an air interface complying with the IEEE 802.11 standard.

17. The method for an AP to support authentication, authorization and accounting (AAA) transactions in a wireless network as set forth in claim 12, wherein the AP performs wireless communications over an air interface complying with the Bluetooth standard.

18. The method for an AP to support authentication, authorization and accounting (AAA) transactions in a wireless network as set forth in claim 12, wherein the AP performs wireless communications over an air interface complying with the HiperLAN2 standard.

19. The method for an AP to support authentication, authorization and accounting (AAA) transactions in a wireless network as set forth in claim 12, wherein the AP performs wireless communications over an air interface complying with the homeRF standard.

20. The method for an AP to support authentication, authorization and accounting (AAA) transactions in a wireless network as set forth in claim 12, wherein the AP performs wireless communications over an air interface complying with a cellular 3G standard.

21. The method for an AP to support authentication, authorization and accounting (AAA) transactions in a wireless network as set forth in claim 12, wherein the communication of the AAA messages is performed without modification to layer 2 protocols of the standards.

22. The method for an AP to support authentication, authorization and accounting (AAA) transactions in a wireless network as set forth in claim 12, wherein IPSEC is used for per-packet decryption of the subsequent messages from the MT.

23. The method for an AP to support authentication, authorization and accounting (AAA) transactions in a wireless network as set forth in claim 12, wherein an IPSEC authentication header is used for per-packet authentication of the subsequent messages from the MT.

24. A method for effecting authentication, authorization and accounting (AAA) transactions in a wireless network, comprising:
establishing an association between a mobile terminal (MT) and an access point (AP);
assigning the MT a dynamic IP address;
until an affirmative authentication determination, filtering all traffic from the dynamic IP address at the AP so that the traffic is not passed beyond the AP;
sending a user initiated login message, from the MT to the AP, including an Internet service provider (ISP) identifier and a user identifier (UID);
sending an access request message, from the AP to the ISP indicated by the ISP identifier, including the UID;
at the ISP, randomly generating a string S₁ and encrypting S₁ with a password of the user to provide encrypted version SS¹;
sending an access challenge message, from the ISP to the AP, including S₁ and SS¹;
storing SS¹ at the AP;
sending a forwarded access challenge message, from the AP to the MT, including S₁;
at the MT, encrypting S₁ with the password of the user to provide encrypted version SS₁, and randomly generating a second string S₂;
sending an access challenge MT response message, from the MT to the AP, including SS₁ and S₂;
making the authentication determination at the AP, wherein:
when SS₁=SS₁, the authentication determination is affirmative,
when the authentication determination is affirmative, sending a follow up access request message, from the AP to the ISP, including the UID, SS₁, and S₂;
when the authentication determination is not affirmative:
ignoring the access challenge MT response message, and
awaiting another access challenge MT response message from the MT;
making an access acceptance determination at the ISP, wherein:
when SS¹=SS₁, the access is accepted by the ISP;
when the access is accepted by the ISP:
encrypting S₂ with the password of the user to provide encrypted version SS²₁, and
sending an access accept message, from the ISP to the AP, including SS²;
when the access is not accepted by the ISP, sending an access reject message from the ISP to the AP;
in response to the access accept message, sending a forwarded access accept message, from the AP to the MT, including SS²;
at the MT, making a trust determination with respect to the AP and ISP, comprising:
decrypting SS² to provide a decrypted version S² of the second string from the ISP; and
when S₂=S², the trust determination is affirmative;
wherein, when the authorization determination is affirmative and the trust determination is affirmative, subsequent traffic from the dynamic IP address is passed beyond the AP without the filtering.

25. The method for effecting authentication, authorization and accounting (AAA) transactions in a wireless network as set forth in claim 24, wherein processing of said AAA transactions is performed using only IP layer functions.

26. The method for effecting authentication, authorization and accounting (AAA) transactions in a wireless network as set forth in claim 24, wherein the forwarded access accept message includes a session key and a broadcast key, and the session key is used for encryption of the subsequent messages from the MT.

27. The method for effecting authentication, authorization and accounting (AAA) transactions in a wireless network as set forth in claim 24, wherein communications between the MT and the AP are performed over an air interface complying with the IEEE 802.11 standard.

28. The method for effecting authentication, authorization and accounting (AAA) transactions in a wireless network as set forth in claim 24, wherein communications between the MT and the AP are performed over an air interface complying with the Bluetooth standard.

29. The method for effecting authentication, authorization and accounting (AAA) transactions in a wireless network as set forth in claim 24, wherein communications between the MT and the AP are performed over an air interface complying with the HiperLAN2 standard.

30. The method for effecting authentication, authorization and accounting (AAA) transactions in a wireless network as set forth in claim 24, wherein communications between the MT and the AP are performed over an air interface complying with the homeRF standard.

31. The method for effecting authentication, authorization and accounting (AAA) transactions in a wireless network as set forth in claim 24, wherein communications between the MT and the AP are performed over an air interface complying with a cellular 3G standard.

32. The method for effecting authentication, authorization and accounting (AAA) transactions in a wireless network as set forth in claim 24, wherein communications during the sending steps are performed without modification to any layer 2 standard protocols.

33. The method for effecting authentication, authorization and accounting (AAA) transactions in a wireless network as set forth in claim 24, wherein IPSEC is used for per-packet encryption of messages from the MT.

34. The method for effecting authentication, authorization and accounting (AAA) transactions in a wireless network as set forth in claim 24, wherein an IPSEC authentication header is used for per-packet authentication of messages from the MT.

35. A method for effecting accounting in a wireless network, comprising:
sending traffic from the MT over the Internet via the AP; and
performing decentralized accounting of the traffic by producing mutual accounting proofs at the MT and the AP.

36. The method for effecting accounting as set forth in claim 35, wherein the method does not include sending packets of the MT through a central virtual operator server.

37. The method for effecting accounting as set forth in claim 35, wherein the producing of mutual accounting proofs comprises:
monitoring the traffic at the MT and the AP to produce respective traffic profiles; and
making a comparison between the traffic profiles.

38. The method for effecting accounting as set forth in claim 37, further comprising sending a verified profile to an ISP based on at least one of the traffic profiles when the comparison indicates a match between the traffic profiles.

39. The method for effecting accounting as set forth in claim 38, wherein the comparison indicates the match between the traffic profiles based on the traffic profiles differing by an amount within a predetermined threshold.

40. The method for effecting accounting as set forth in claim 37, further comprising blocking the traffic from the MT when the comparison indicates no match between the respective traffic profiles.

41. The method for effecting accounting as set forth in claim 37, wherein, when the comparison indicates no match between the respective traffic profiles, the AP permits the MT to adopt the respective traffic profile of the AP.

42. The method for effecting accounting as set forth in claim 41, wherein, when the MT does not adopt the respective traffic profile of the AP, the traffic from the MT is blocked.

43. An access point (AP) for a wireless network, comprising a processor and a memory under control of the processor, the memory having instructions enabling the processor to perform the steps of:
accepting an association with a mobile terminal (MT);
establishing an authentication channel with an Internet service provider (ISP); and
receiving AAA messages sent from the MT, and sending corresponding AAA messages to the ISP, to effect said AAA transactions;
wherein processing of said AAA transactions is performed using only IP layer functions.

44. The access point as set forth in claim 43, wherein said receiving and said sending of said AAA messages comprises:
until an affirmative authentication determination, filtering all traffic from the MT so that the traffic is not passed beyond the AP;
receiving an Internet service provider (ISP) identifier and a user identifier (UID) from the MT;
sending the UID from the AP to the ISP indicated by the ISP identifier;
receiving a first encrypted string SS¹ and a first string S₁ from the ISP;
sending S₁ to the MT;
receiving from the MT a second encrypted string SS₁;
when SS¹=SS₁:
making the affirmative authentication determination,
sending the UID and SS₁ to the ISP, and
passing subsequent traffic from the MT without the filtering.

45. The access point as set forth in claim 44, further comprising:
when receiving from the MT the second encrypted string SS₁, receiving also a second string S₂; and
when sending the UID and SS₁ to the ISP, sending also S₂.

46. The access point as set forth in claim 44, further comprising, when SS¹=SS₁, sending to the MT a session key, wherein the session key is used for decryption of the subsequent messages from the MT.

47. The access point as set forth in claim 43, wherein the AP performs wireless communications over an air interface complying with the IEEE 802.11 standard.

48. The access point as set forth in claim 43, wherein the AP performs wireless communications over an air interface complying with the Bluetooth standard.

49. The access point as set forth in claim 43, wherein the AP performs wireless communications over an air interface complying with the HiperLAN2 standard.

50. The access point as set forth in claim 43, wherein the AP performs wireless communications over an air interface complying with the homeRF standard.

51. The access point as set forth in claim 43, wherein the AP performs wireless communications over an air interface complying with a cellular 3G standard.

52. The access point as set forth in claim 43, wherein the communication of the AAA messages is performed without modification to layer 2 protocols of the standards.

53. The access point as set forth in claim 43, wherein IPSEC is used for per-packet decryption of the subsequent messages from the MT.

54. The access point as set forth in claim 43, wherein an IPSEC authentication header is used for per-packet authentication of the subsequent messages from the MT.
